(19) United States
(12) Patent Application Publication
(10) Pub. No.: US 2018/0259362 A1
(43) Pub. Date: Sep. 13, 2018

(54) APPARATUS FOR DETECTING A ROTATIONAL MOVEMENT

(71) Applicant: HELLA GmbH & Co. KGaA, Lippstadt (DE)

(72) Inventors: Steffen HOPPE, Lippstadt (DE); Marcus IRRGANG, Luenen (DE)

(73) Assignee: HELLA GmbH & Co. KGaA, Lippstadt (DE)

(21) Appl. No.: 15/978,571

(22) Filed: May 14, 2018

Related U.S. Application Data
(63) Continuation of application No. PCT/EP2016/077477, filed on Nov. 11, 2016.

(30) Foreign Application Priority Data
Nov. 12, 2015 (DE) 10 2015 119 530.5

(51) Int. Cl. G01D 5/20; H01Q 1/36; G01B 7/00

(52) U.S. Cl. CPC G01D 5/2053; G01B 7/003; H01Q 1/36

(57) ABSTRACT

A device for detecting a rotational movement of an inductive element, including an antenna and electronic controller and evaluator, wherein the antenna is designed to emit and receive electromagnetic radiation and define an antenna area, and wherein the controller and evaluator are designed to output electronic signals to the antenna and to receive them from the antenna, wherein the controller and evaluator are arranged in the antenna area.

This nonprovisional application is a continuation of International Application No. PCT/EP2016/077477, which was filed on Nov. 11, 2016, and which claims priority to German Patent Application No. DE 10 2015 119 530.5, which was filed in Germany on Nov. 12, 2015, and which are both herein incorporated by reference.

### BACKGROUND OF THE INVENTION

### Field of the Invention

The present invention relates to a device for detecting a rotational movement of an inductive element.

### Description of the Background Art

A device is known from the prior art as a first part of an inductive sensor. There is a control and evaluation electronics system and several conductors as antennas. As a result, excitation antennas and receiving antennas are available. Electromagnetic radiation can be emitted via the excitation antennas. This is received by an inductive element, as the second part of the inductive sensor. In this inductive element, an electric current is induced, which in turn emits electromagnetic radiation, which can then be received by the receiving antennas of the device. The inductive element can also be referred to as a rotary encoder.

Usually, the excitation antennas are arranged along a circular arc section. The receiving antennas are arranged inside the circle defined by this circular arc section. However, it is also possible that the receiving antennas are arranged along a circular arc section and the excitation antennas are arranged inside the circle defined by this circular arc section. During operation, the circle is arranged on or opposite a component whose rotational movement and/or position is to be determined by the inductive sensor. The inductive element is arranged such that its antennas are arranged opposite the antennas of the device.

The antennas of the inductive element are flat, so that the electromagnetic radiation emitted by it is particularly strongly received by the receiving antennas of the device when the planar antennas of the inductive element sweep the receiving antennas of the device. The received signal is then evaluated by the control and evaluation electronics system. The receiving antennas of the device divide the circle defined by the circular arc section into a plurality of sections. Upon rotation of the inductive element relative to the device, the planar antennas of the inductive element sweep over the receiving antennas of the device. From the resulting electrical signal, the control and evaluation electronics system determines the speed of rotation and/or the relative orientation of the inductive element relative to the device. The inductive sensor is used, for example, to determine the position and rotational movement of a camshaft or the position of a pedal.

In the prior art, the control and evaluation electronics system is usually disposed outside the circle defined by the circular arc section, so that the device requires a relatively large amount of space and is not rotationally symmetric.

### SUMMARY OF THE INVENTION

It is therefore an object of the present invention to provide a device that requires less space. In addition, a system is to be created comprising such a device and a rotatable inductive element.

In an exemplary embodiment, the device comprises an antenna and an electronic controller and evaluator. The antenna is designed for the emission and reception of electromagnetic radiation. For example, the antenna may be conductors on a printed circuit board. First conductors for emitting and second conductors for receiving may be formed. The antenna defines an antenna area. The antenna area can thus be adapted to the shape and arrangement of the antenna. In particular, the antenna area may be limited by a portion of the antenna, for example the antenna can be designed to emit radiation. It is also possible that an imaginary extension of the geometric shape of the portion of the antenna represents the boundary of the antenna area. For example, if the antenna for emitting radiation can be disposed on a circular arc section, the antenna area may be defined by the circle defined by the circular arc portion.

The controller and evaluator are designed to output electronic signals to the antenna and to receive them from the antenna. The controller and evaluator can thus control when radiation is emitted by the antenna and evaluate signals received by the antenna.

Upon rotation of the inductive element relative to the device, the antenna of the device emits electromagnetic radiation which generates a current in the inductive element, which in turn leads to the emission of electromagnetic radiation. Said electromagnetic radiation is received by the antenna of the device and the resulting signal is routed to the controller and evaluator. The controller and evaluator are designed to determine the position and/or the rotational speed of the inductive element relative to the device from the signal.

The invention provides that the controller and evaluator are arranged in the antenna area. As a result, less space is required because no additional installation space is needed for the controller and evaluator. In the prior art, the arrangement of the controller and evaluator outside the antenna area is also disadvantageous, since the device is no longer rotationally symmetrical in the case of a rotationally symmetrical antenna area due to the additional installation space for the controller and evaluator.

The arrangement of the controller and evaluator within the antenna area was not taken into consideration in the prior art, because in particular, the amount of information collected by the device with respect to the rotational movement is reduced because either less space for the antenna is available and/or the controller and evaluator influence the electromagnetic radiation. This adversely affects the accuracy of the device. However, this reduction in accuracy can often be accepted since the accuracy is still sufficient and saving space is more important.

Due to the arrangement of the controller and evaluator within the antenna area, it is possible that the antenna do not completely cover the antenna area. The subarea in which the controller and evaluator are arranged may be free of antenna. In this case, the antennas of the inductive element whose rotation and/or position is to be measured may be arranged in a circular or non-circular manner.

It is particularly advantageous that the device according to the invention can be used in conjunction with an inductive element known from the prior art so that production costs are reduced. Alternatively, it is also possible to use an inductive element whose antennas are arranged asymmetrically.

The antenna area may be rotationally symmetrical. This is particularly advantageous if—as is often the case in automotive construction when using the device for detecting the position and/or rotational movement of waves—the space available for the device is particularly narrow and also rotationally symmetrical.

The antenna area may be formed as a circle or as a circular arc section. This is particularly advantageous when the position and/or rotational movement of a component is to be detected, which has a circular cross-sectional area.

The antenna area may be defined by the arrangement and shape of the antenna. It is thus possible for the antenna area to exclusively comprise areas which correspond to the shape and the arrangement of the antenna. If, for example, the antenna can be arranged substantially in a circle, the antenna area also has a circular shape.

The antenna area may comprise an area which is defined by an imaginary extension of at least a part of the antenna while maintaining the geometric shape. If, for example, the antenna designed to emit electromagnetic radiation can be arranged in a circular arc section, the antenna region can be defined by the circle defined by the circular arc section. The antenna area can be limited in particular to this circle.

At least a portion of the antenna may be arranged along a circular arc section. This portion of the antenna may for example comprise the antenna, which are designed to emit electromagnetic radiation. The antenna area in this case may include the entire circle defined by the circular arc section.

The device may comprise at least one electronic component that is part of the antenna as well as a component of the controller and evaluator. In this way, particularly high accuracy of the device is achieved in accordance with the small installation space of the invention, since this electronic component has a dual function as an antenna and as a component of the controller and evaluator. It may be, for example, a capacitor which is arranged in extension of a conductor as part of the antenna and at the same time, is part of the controller and evaluator.

The device may comprise a printed circuit board on which the antenna and the controller and evaluator are arranged. This is a particularly space-saving design of the device.

According to an embodiment of the invention, the controller and evaluator and the antenna may be arranged on the circuit board at least partly superimposed. In this way, the space can be used very efficiently. In a plan view of the circuit board, it is possible that components of the controller and evaluator partially cover the antenna.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic plan view of a device according to an embodiment of the invention;

FIG. 2 is a schematic plan view of an embodiment of the invention;

FIG. 3 is a schematic plan view of an embodiment of the invention; and

FIG. 4 is a detailed view of the device in FIG. 3.

### DETAILED DESCRIPTION

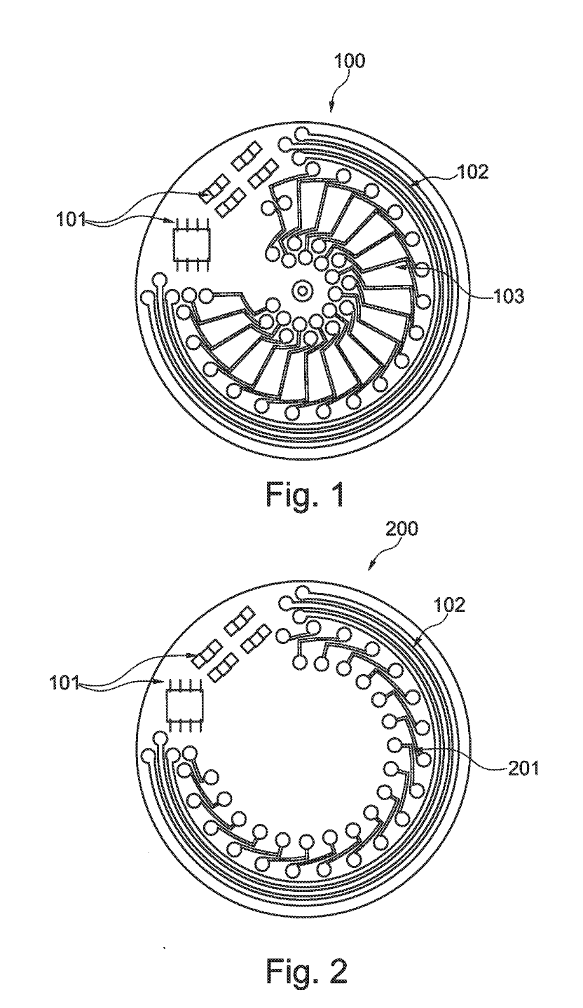

The device 100 shown in FIG. 1 is used to detect a rotational movement of an inductive element, not shown. The inductive element can be arranged, for example, on a rotatable component and also rotate during a rotation of this component.

The device 100 comprises controller and evaluator 101 and antenna 102 and 103. The antenna 102 can be designed to emit electromagnetic radiation. The antenna 103 can be designed to receive electromagnetic radiation. The antenna 102 can be electrically connected to the controller and evaluator 101, so that the controller and evaluator can trigger the emission of electromagnetic radiation by means of the antenna 102. During operation of the device, the electromagnetic radiation emitted by the antenna 102 is received by the inductive sensor. The inductive sensor comprises one or more conductors in which an electrical current is induced by the electromagnetic radiation. The former in turn triggers the emission of electromagnetic radiation, which is then received by the antenna 103 and there, triggers a current flow. The antenna 103 can be electrically connected to the controller and evaluator 101 so that the induced current flow reaches the controller and evaluator 101 and is evaluated there. Due to the plurality of antenna 103, the rotational movement and/or the position of the inductive element relative to the device 100 can be measured.

The antenna 102 and 103 define by their position and orientation an antenna area, which is circular and thus rotationally symmetric. The outermost conductor, which is part of the antenna 102, defines the circumference of the circle. The controller and evaluator 101 are arranged within this antenna area so that the device 100 is also rotationally symmetrical. This rotationally symmetrical shape has the advantage that the device can be used particularly well if the available installation space is small. In addition, the device can be arranged in a particularly space-saving manner on rotating components.

The device 200 illustrated in FIG. 2 is designed substantially like the device 100 in FIG. 1. The only difference is that there is an open space in the inner subsection of the antenna area so that a recess can be incorporated here, through which the component, on which the device 200 is arranged, can protrude.

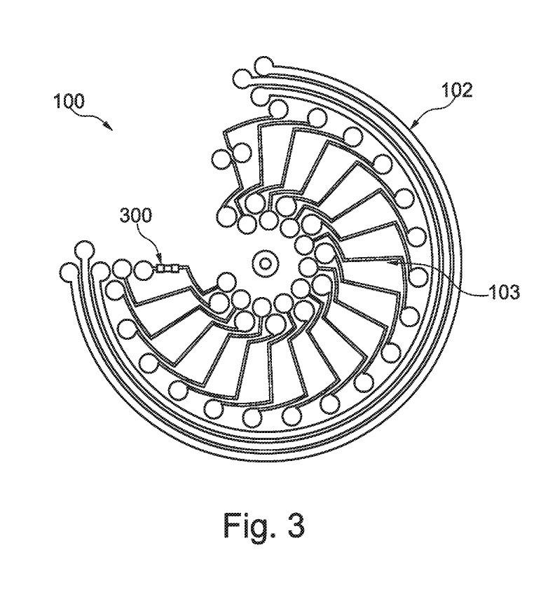

FIG. 3 shows the device 100, with the difference that an electronic component 300 is both a component of the antenna 103 and of the controller and evaluator 101. As a result, further installation space can be saved or the available installation space can be used more efficiently for two functions. The remaining components of the controller and evaluator 101 are not shown for reasons of clarity. For example, they may be arranged similarly as shown in FIG. 1. The electronic component 300 may be, for example, a capacitor.

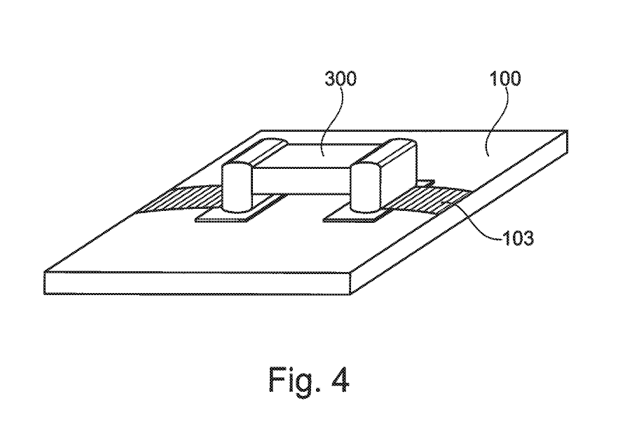

FIG. 4 shows the electronic component 300 in more detail. For example, it can be electrically connected to a conductor at its two ends, so that it is a part of the antenna 103. The electronic component can be connected to the controller and evaluator 101 by means of this conductor, so that it too is a component thereof.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for detecting a rotational movement of an inductive element, the device comprising:
an antenna adapted to emit and receive electromagnetic radiation, the antenna defining an antenna area; and
an electronic controller and evaluator adapted to output electronic signals to the antenna and to receive the electronic signals from the antenna,
wherein the controller and evaluator are arranged in the antenna area.

2. The device according to claim 1, wherein the antenna area is rotationally symmetrical.

3. The device according to claim 1, wherein the antenna area is formed as a circle or as a circular arc section.

4. The device according to claim 1, wherein the antenna area is defined by the arrangement and shape of the antenna.

5. The device according to claim 1, wherein the antenna area comprises a region which is defined by an imaginary extension of at least a portion of the antenna while maintaining the geometric shape.

6. The device according to claim 1, wherein at least a portion of the antenna is arranged along a circular arc section, and wherein the antenna area comprises an entire circle defined by the circular arc section.

7. The device according to claim 1, wherein the device comprises at least one electronic component, which is both a component of the antenna and part of the controller and evaluator (101).

8. The device according to claim 1, wherein the device comprises a printed circuit board on which the antenna and the electronic controller and evaluator are arranged.

9. The device according to claim 8, wherein the controller and evaluator and the antenna are arranged on the printed circuit board at least partially superimposed.

10. A system comprising:
a device according to claim 1; and
a rotatable inductive element, the inductive element comprising at least one further antenna, which is adapted to receive electromagnetic radiation from the antenna of the device and, in response, to emit electromagnetic radiation towards the antenna of the device.
